(19) United States
(12) Patent Application Publication
(10) Pub. No.: US 2025/0044909 A1
(43) Pub. Date: Feb. 6, 2025

(54) Content Display Method and Apparatus, Electronic Device, Storage Medium, and Program Product

(71) Applicant: Beijing Zitiao Network Technology Co., Ltd., Beijing (CN)

(72) Inventor: Pei YANG, Beijing (CN)

(21) Appl. No.: 18/717,240

(22) PCT Filed: Dec. 5, 2022
(86) PCT No.: PCT/CN2022/136590

§ 371 Date: Jun. 6, 2024

(30) Foreign Application Priority Data
Dec. 10, 2021 (CN) 202111510025.2

(51) Int. Cl. G06F 3/0481; G06F 3/04845

(52) U.S. Cl. CPC G06F 3/0481; G06F 3/04845; G06F 2203/04803

(57) ABSTRACT

The present disclosure provides a content display method, a content display apparatus, an electronic device, a storage medium, and a program product. The method includes: receiving a display operation for a target multimedia content, the target multimedia content being a content associated with a preset keyword; and in response to the display operation, displaying the target multimedia content in a target content display region of a display page, and presenting an associated effect for the preset keyword in a first effect display region associated with the target content display region, where at least two content display regions are provided in a main display region of the display page, the at least two content display regions include the target content display region, and a content display region other than the target content display region is located outside the first effect display region.

The present disclosure claims the priority to Chinese Patent Application No. 202111510025.2, filed with the Chinese Patent Office on Dec. 10, 2021, the entire disclosure of which is incorporated herein by reference as part of the disclosure of this application.

### TECHNICAL FIELD

Embodiments of the present disclosure relate to the field of computer technology, for example, to a content display method, a content display apparatus, an electronic device, a storage medium, and a program product.

### BACKGROUND

In the related art, in general, when specific multimedia contents and other multimedia contents other than the specific multimedia contents are presented in the same manner on a display page, the presentation form of the specific multimedia contents is relatively single, which may result in poor experience of users.

### SUMMARY

The embodiments of the present disclosure provide a content display method, a content display apparatus, an electronic device, a storage medium, and a program product, so as to enrich presentation forms of specific multimedia contents to create an immersive viewing atmosphere for users.

In a first aspect, the embodiments of the present disclosure provide a content display method, and the method includes:
receiving a display operation for a target multimedia content, where the target multimedia content is a content associated with a preset keyword; and
in response to the display operation, displaying the target multimedia content in a target content display region of a display page, and presenting an associated special effect for the preset keyword in a first special effect display region associated with the target content display region, where at least two content display regions are provided in a main display region of the display page, the content display regions comprise the target content display region, and a content display region other than the target content display region is located outside the first special effect display region.

In a second aspect, the embodiments of the present disclosure further provide a content display apparatus, and the apparatus includes:
a receiving module, configured to receive a display operation for a target multimedia content, where the target multimedia content is a content associated with a preset keyword; and
a display module, configured to, in response to the display operation, display the target multimedia content in a target content display region of a display page, and present an associated special effect for the preset keyword in a first special effect display region associated with the target content display region, where at least two content display regions are provided in a main display region of the display page, the content display regions comprise the target content display region, and a content display region other than the target content display region is located outside the first special effect display region.

In a third aspect, the embodiments of the present disclosure further provide an electronic device, including a processor and a memory; the memory is configured to store a program; and the program, when executed by the processor, causes the processor to implement the content display method according to the embodiments of the present disclosure.

In a fourth aspect, the embodiments of the present disclosure further provide a computer-readable storage medium; a computer program is stored on the computer-readable storage medium; and the computer program, when executed by a processor, causes the processor to implement the content display method according to the embodiments of the present disclosure.

In a fifth aspect, the embodiments of the present disclosure further provide a computer program product; and the computer program product, when executed by a computer, causes the computer to implement the content display method according to the embodiments of the present disclosure.

### BRIEF DESCRIPTION OF THE DRAWINGS

Throughout the accompanying drawings, identical or similar reference numerals represent identical or similar elements. It should be understood that, the accompanying drawings are schematic, and components and elements are not necessarily drawn to scale.

FIG. 1 is a flowchart of a content display method provided by an embodiment of the present disclosure;

FIG. 2 is a schematic diagram of a display page provided by an embodiment of the present disclosure;

FIG. 3 is a schematic diagram of another display page provided by an embodiment of the present disclosure;

FIG. 4 is a flowchart of another content display method provided by an embodiment of the present disclosure;

FIG. 5 is a structural block diagram of a content display apparatus provided by an embodiment of the present disclosure; and

FIG. 6 is a schematic structural diagram of an electronic device provided by an embodiment of the present disclosure.

### DETAILED DESCRIPTION

The embodiments of the present disclosure will be described below with reference to the accompanying drawings. While certain embodiments of the present disclosure are shown in the drawings, it should be understood that the present disclosure may be embodied in various forms and should not be construed as limited to the embodiments set forth herein. It should be understood that the drawings and embodiments of the present disclosure are only for exemplary purposes.

It should be understood that the various steps described in the method implementations of the present disclosure may be performed in different orders and/or in parallel. Furthermore, the method implementations may include additional steps and/or omit performing the illustrated steps.

As used herein, the terms “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units.

It should be noted that the modifications of “a,” “an,” “a plurality of,” and the like mentioned in the present disclosure are illustrative rather than restrictive, and those skilled in the art should understand that unless the context clearly indicates otherwise, these modifications should be understood as “one or more.”

The names of messages or information exchanged between multiple devices in the implementations of the present disclosure are only for illustrative purposes, and are not intended to limit the scope of these messages or information.

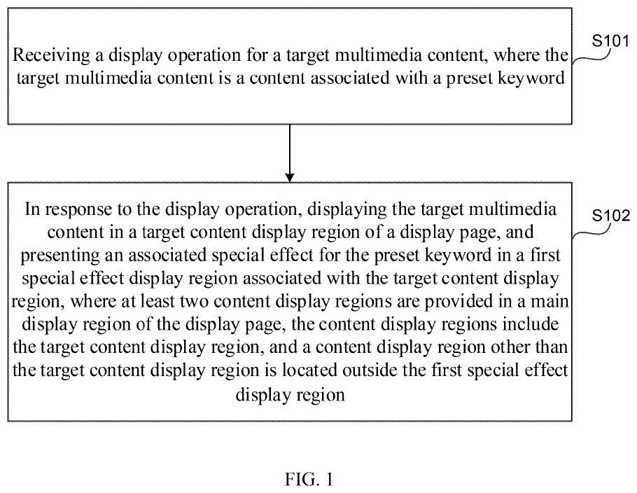

FIG. 1 is a flowchart of a content display method provided by an embodiment of the present disclosure. The method can be performed by a content display apparatus, wherein the apparatus can be implemented by software and/or hardware and may be configured in an electronic device, for example, may be configured in a mobile phone or a tablet computer. The content display method provided by the embodiments of the present disclosure is applicable to a scenario of presenting contents related to a specific keyword in a set ranking list. As shown in FIG. 1, the content display method provided by the present embodiment may include:
S101: receiving a display operation for a target multimedia content, where the target multimedia content is a content associated with a preset keyword.

The target multimedia content may be a multimedia content related to a preset keyword. The multimedia content may be the content published on the platform, such as a video or an article. The preset keywords may be keywords configured with associated special effects, such as keywords related to snow, rain, meteor, or aerospace.

The display operation may be understood as an operation for instructing the electronic device to present a target multimedia content, such as a search operation including the preset keyword or a viewing operation for multimedia contents related to the preset keyword. For example, the display operation is at least one of a search operation or a viewing operation, the search result of the search operation includes the target multimedia content, and the viewing operation is a viewing operation for the target multimedia content.

In one implementation, a user may enter a search term in a search box and perform a search operation, such as triggering a search control. Accordingly, the electronic device may acquire a search result matching the search term input by the user from the server after receiving the search operation of the user, and determine whether the search result contains multimedia contents associated with the preset keyword. If so, the electronic device may take the multimedia contents as the target multimedia contents, and determine that a display operation for the target multimedia contents is received; and if not, the respective multimedia contents contained in the search result may be presented directly on the display page.

Here, the search result may include a plurality of pieces of multimedia contents matching the search term, and each piece of the multimedia contents may be a target multimedia content associated with the preset keyword or may also be a non-target multimedia content that is not associated with the preset keyword.

It can be understood that, in the above implementation, it may only consider whether the target multimedia content is contained in the search result, and if the target multimedia content is contained in the search result, the search operation of the user is determined as the display operation for the target multimedia content. It is also possible to consider whether the preset keyword is included in the search term input by the user, and the search operation of the user is determined as the display operation for the target multimedia content only when the preset keyword is included in the search term input by the user and the target multimedia content is included in the search result, so as to avoid presenting the special effect related to the preset keyword to disturb the user when the user searches for contents not including the preset keyword.

In another implementation, the user may directly view the multimedia content related to the preset keyword. For example, when the electronic device displays the content information of the multimedia content, the user may perform a viewing operation for the multimedia content that the user intends to view, such as triggering the content information of the multimedia content that the user intends to view. Accordingly, after receiving the viewing operation of the user, the electronic device may determine whether the multimedia content to which the content information belongs is associated with the preset keyword; if so, the electronic device may take the multimedia content as the target multimedia content, and determine that a display operation for the target multimedia content is received; and if not, the multimedia content may be presented directly on the display page. Here, the content information of the multimedia content may include a topic name of a topic to which the multimedia content belongs, a title and/or a cover page of the multimedia content, and the like.
S102: in response to the display operation, displaying the target multimedia content in a target content display region of a display page, and presenting an associated special effect for the preset keyword in a first special effect display region associated with the target content display region, where at least two content display regions are provided in a main display region of the display page, the content display regions include the target content display region, and a content display region other than the target content display region is located outside the first special effect display region.

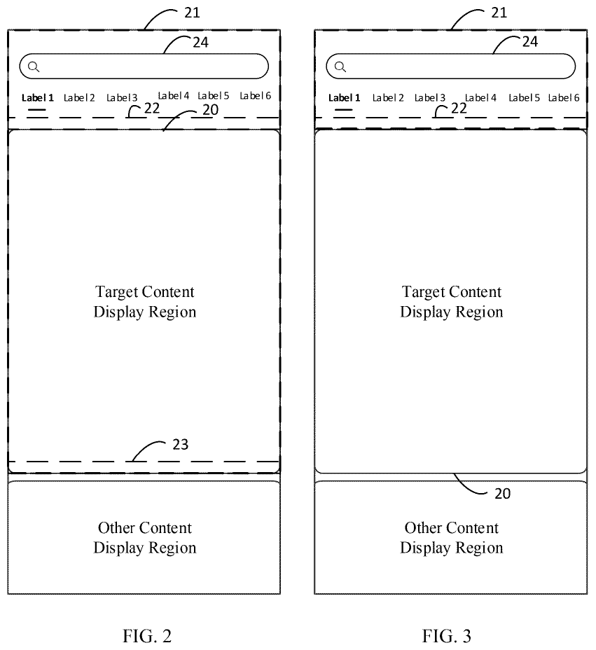

As illustrated in FIG. 2 and FIG. 3, the display page may be a multimedia content display page, i.e., a page for displaying a target multimedia content. At least two content display regions may be provided in a main display region of the display page; and when the target multimedia content is present, one of the at least two content display regions may be used for displaying the target multimedia content, and other content display regions of the at least two content display regions may be used for displaying other contents, such as for displaying non-target multimedia contents contained in the corresponding topic or search result. Accordingly, the target content display region 20 may be the content display region of the display page in which the target multimedia content is located, and for example, the target content display region 20 may be the first content display region in the main display region of the display page. In addition, when there is no target multimedia content, that is, when the contents which need to be displayed on the display page do not include the target multimedia content, the target content display region may not be included in the main display region of the display page.

The associated special effect is a special effect associated with the preset keyword, and the associated special effect can be used to present a visual image related to the preset keyword. For example, when the preset keyword is a keyword related to “snow,” the associated special effect may be a snow-related special effect; when the preset keyword is a keyword related to “rain,” the associated special effect may be a rain-related special effect; and when the preset keyword is a keyword related to “meteor,” the associated special effect may be a meteor-related special effect.

The first special effect display region 21 may be a region for presenting the associated special effects of the preset keyword, and may be a special effect display region associated with the target content display region 20, for example, a special effect display region overlapping with the boundary of the target content display region 20, or a special effect display region intersecting or corresponding to the target content display region 20, in which case the target content display region 20 may optionally be located within the first special effect display region 21 or outside the first special effect display region 21. For example, when the target content display region 20 is located outside the first special effect display region 21, the target content display region 20 may be located below the first special effect display region 21. For example, the left boundary of the first special effect display region 21 may be collinear with the left boundary of the target content display region 20; the right boundary of the first special effect display region 21 may be collinear with the right boundary of the target content display region 20; the upper boundary of the first special effect display region 21 may be located above the upper boundary of the target content display region 20, e.g., being coincident with the upper boundary of the display page or spaced apart by a predetermined distance; or the lower boundary of the first special effect display region 21 may coincide with the upper or lower boundary of the target content display region 20 (as shown in FIG. 2 and FIG. 3) or be spaced apart by a predetermined distance.

For example, as shown in FIG. 2 and FIG. 3, when a display operation for the target multimedia content is received, the target multimedia content may be displayed in the target content display region 20 of the display page (e.g., the first display region on the display page), and the first associated special effect of the preset keyword may be presented in the first special effect display region 21 associated with the target content display region 20. Taking the preset keyword being the keyword related to “snow” as an example, the target multimedia content related to “snow” and included in the set ranking list may be displayed in the target content display region 20, and the special effects related to “snow,” such as the special effect of showing snowflake falling, may be presented in the first special effect display region 21. Here, the snowflake particles in the special effect may be simulated by a 3D particle simulation tool, such as 3D Trapcode Particular, so as to improve the level of verisimilitude of the snowflake particles shown in the special effect.

In this embodiment, when the target multimedia content associated with the preset keyword is displayed, the special effects associated with the preset keyword are presented in and only in the special effect display region associated with the target content display region in which the target multimedia content is located. Thus, it not only can enhance the fun of display of the multimedia content and create an immersive viewing experience for the user, but also can highlight the target multimedia content presented on the page by the special effects as compared to presenting the special effects related to the preset keyword on the entire display page, so as to improve the recognizability of the target multimedia content and the user's attention to the target multimedia content, thereby improving the experience of the user.

In this embodiment, all the multimedia contents associated with the preset keyword may be displayed when the multimedia contents associated with the preset keyword are displayed. It may also present the special effect associated with the preset keyword only when a content, which complies with the preset condition, among the multimedia contents associated with the preset keyword is displayed, in which case, optionally, the target multimedia content is a content, which complies with the preset condition, among the contents associated with the preset keyword. Here, the preset condition may be flexibly set as desired, for example, the preset condition may be located within a set ranking list (e.g., a hotspot ranking list or a trending ranking list) or located in top M (M is a positive integer) positions of the set ranking list, or satisfy the set conditions for the popularity, the like count, the forwarding count, or the comment count of the multimedia content.

The content display method provided by the embodiment receives a display operation for a target multimedia content associated with a preset keyword, and in response to the display operation, display the target multimedia content in a target content display region of a display page, and present an associated special effect for the preset keyword in a first special effect display region associated with the target content display region, where at least two content display regions, including the target content display region, are provided in a main display region of the display page, and a content display region other than the target content display region is located outside the first special effect display region. By adopting the above technical solution, in the present embodiment, when the target multimedia content associated with the preset keyword is displayed, the special effects associated with the preset keyword are presented in the special effect display region associated with the content display region in which the target multimedia content is located, which thus can not only enhance the fun of display of the multimedia content and create an immersive viewing experience for the user, but also can highlight the target multimedia content presented on the page by the special effects, so as to improve the recognizability of the target multimedia content and improve the user's attention to the target multimedia content, thereby improving the experience of the user.

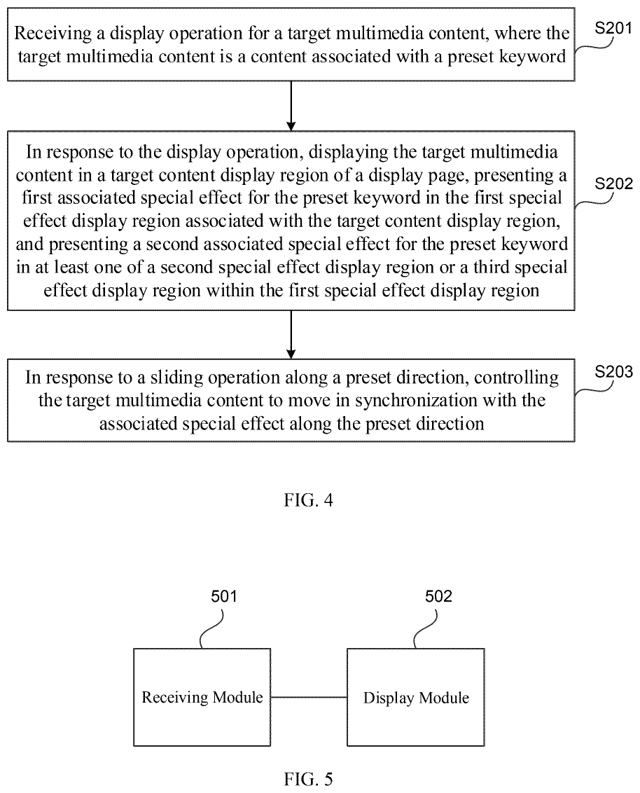

FIG. 4 is a flowchart of another content display method provided by an embodiment of the present disclosure. The solutions in the embodiment may be combined with one or more optional solutions in the above embodiments. Optionally, presenting the associated special effect for the preset keyword in the first special effect display region associated with the target content display region includes: presenting a first associated special effect for the preset keyword in the first special effect display region associated with the target content display region.

Optionally, presenting the associated special effect for the preset keyword in the first special effect display region associated with the target content display region further includes: presenting a second associated special effect for the preset keyword in a second special effect display region within the first special effect display region, where the second special effect display region is located above the target content display region.

Optionally, presenting the associated special effect for the preset keyword in the first special effect display region associated with the target content display region further includes: presenting the second associated special effect for the preset keyword in a third special effect display region within the first special effect display region, where the third special effect display region is located within the target content display region.

Optionally, the content display method provided by the embodiment further includes: in response to a sliding operation along a preset direction, controlling the target multimedia content to move in synchronization with the associated special effect along the preset direction.

Accordingly, as shown in FIG. 4, the content display method provided by the present embodiment may include:
S201: receiving a display operation for a target multimedia content, where the target multimedia content is a content associated with a preset keyword.
S202: in response to the display operation, displaying the target multimedia content in a target content display region of a display page, presenting a first associated special effect for the preset keyword in the first special effect display region associated with the target content display region, and presenting a second associated special effect for the preset keyword in at least one of a second special effect display region or a third special effect display region within the first special effect display region, where at least two content display regions are provided in a main display region of the display page, the target content display region is located within the first special effect display region, a content display region other than the target content display region is located outside the first special effect display region, the second special effect display region is located above the target content display region, and the third special effect display region is located within the target content display region.

The first associated special effect is a special effect associated with the preset keyword, and the first associated special effect can be used to present a visual image related to the preset keyword. For example, when the preset keyword is a keyword related to “snow,” the first associated special effect may be a special effect of snowflake falling; when the preset keyword is a keyword related to “rain,” the first associated special effect may be a special effect of raindrops falling; and when the preset keyword is a keyword related to “meteor,” the first associated special effect may be a special effect of meteor streaking across the sky.

The second associated special effect is a special effect associated with the preset keyword, and the second associated special effect can be used to present a visual image which is related to the preset keyword and different from the first associated special effect. For example, the second associated special effect may be used to present an image associated with the special effect in the first associated special effect. For example, when the preset keyword is a keyword related to “snow,” the second associated special effect may be a special effect of snowflake piling; when the preset keyword is a keyword related to “rain,” the second associated special effect may be a special effect that raindrops converge into water; and when the preset keyword is a keyword related to “meteor,” the second associated special effect may be a special effect in which the meteor falls into the bottom of the corresponding special effect display region. Here, optionally, the first associated special effect and the second associated special effect each include a plurality of target objects associated with the preset keyword, the target objects included in the first associated special effect move downwards in the first special effect display region, and the target objects included in the second associated special effect are stacked at bottom of the second special effect display region. Here, the target object may be an object associated with the preset keyword, such as the snowflake, raindrop, meteor, or the like. The target object moving downwards may be understood as the target object having a downward velocity component within the display page. When the target objects are stacked, the target objects may still be presented in the form of multiple target objects at the stacked position, or may be stacked into an other object (for example, snowdrift, water, etc.) associated with the preset keyword and presented in the form of the other object.

The second special effect display region 22 may be a region for presenting the second associated special effect, which may be a special effect display region associated with the target content display region 20, such as a special effect display region that overlaps with the boundary of the target content display region 20 or intersects or corresponds to the target content display region 20. For example, the second special effect display region 22 may be located above the target content display region 20. For example, the left boundary of the second special effect display region 22 may be collinear with the left boundary of the target content display region 20; the right boundary of the second special effect display region 22 may be collinear with the right boundary of the target content display region 20; the upper boundary of the second special effect display region 22 may be located above the target content display region 20, such as between the upper boundary of the target content display region 20 and the upper boundary of the first special effect display region 21; or the lower boundary of the second special effect display region 22 may coincide with the upper boundary of the target content display region 20 (as shown in FIG. 2 and FIG. 3) or be spaced apart by a predetermined distance.

The third special effect display region 23 may be another region for presenting the second associated special effect, which may be a special effect display region associated with the target content display region 20, such as a special effect display region that overlaps with the boundary of the target content display region 20 or intersects or corresponds to the target content display region 20. For example, the third special effect display region 23 may be located within the target content display region 20, such as at the bottom of the target content display region. For example, the left boundary of the third special effect display region 23 may coincide with or be separated by a preset distance from the left boundary of the target content display region 20; the right boundary of the third special effect display region 23 may coincide with or be separated by a preset distance from the right boundary of the target content display region 20; the upper boundary of the third special effect display region 23 may be located between the upper and lower boundaries of the target content display region 20; or the lower boundary of the third special effect display region 23 may coincide with the lower boundary of the target content display region 20 (as shown in FIG. 2) or be spaced apart by a predetermined distance.

For example, as shown in FIG. 2, when the target content display region 20 is located within the first special effect display region 21, the target multimedia content may be displayed in the target content display region 20, the first associated special effect for the preset keyword may be presented in the first special effect display region 21 associated with the target content display region 20, and the second associated special effect for the preset keyword may be presented in at least one of the second special effect display region 22 or the third special effect display region 23 associated with the target content display region 20.

As shown in FIG. 3, when the target content display region 20 is located outside the first special effect display region 21, the target multimedia content may be displayed in the target content display region 20, the first associated special effect for the preset keyword may be presented in the first special effect display region 21 associated with the target content display region 20, and the second associated special effect for the preset keyword may be presented in the second special effect display region 22 associated with the target content display region 20.

Taking the preset keyword being the keyword related to “snow” as an example, the target multimedia content related to “snow” may be displayed in the target content display region, the special effect of snowflake falling may be presented in the first special effect display region, and the special effect of snowflake piling may be presented in at least one of the second special effect display region or the third special effect display region, thereby presenting the visual effect of snowflake falling and piling at the top and/or bottom of the target content display region, thus creating a more realistic snowy atmosphere.

In one implementation, a navigation bar display region is further provided on the display page, the navigation bar display region is located above the main display region, the first associated special effect is presented in a lower layer with respect to a first content displayed in the target content display region, and is displayed in an upper layer with respect to a second content displayed in the navigation bar display region, and the second associated special effect is presented in an upper layer with respect to the second content displayed in the navigation bar display region, the first content including the target multimedia content.

Here, the first content may be understood as the content displayed in the target content display region 20, which may include the content of the target multimedia content; and the second content may be understood as the content displayed in the navigation bar display region located above the main display region of the display page, such as the page labels (Label 1, Label 2, Label 3, Label 4, Label 5, and Label 6 as shown in FIG. 2 and FIG. 3) displayed in the display page and/or the search box 24 as shown in FIG. 2 and FIG. 3.

In the above implementation, the first associated special effect may be presented in a lower layer of the first content displayed in the target content display region and in an upper layer of the second content displayed in the navigation bar display region. Furthermore, when the second associated special effect for the preset keyword needs to be presented, the second associated special effect may be presented in an upper layer of at least one of the first content displayed in the target content display region or the second content displayed in the navigation bar display region. For example, assuming that the display page includes a first image layer, a second image layer, a third image layer, and a fourth image layer which are sequentially stacked from top to bottom in the direction perpendicular to the screen, the second associated special effect may be presented in the first image layer, the first content, which includes the target multimedia content and is displayed in the target content display region, may be displayed in the second image layer, the first associated special effect may be presented in the third image layer, and the second content displayed in the navigation bar display region may be displayed in the fourth image layer.

In another implementation, a navigation bar display region is further provided on the display page, the navigation bar display region is located above the main display region, the first associated special effect is presented in an upper layer with respect to a first content displayed in the target content display region and a second content displayed in the navigation bar display region, and the second associated special effect is presented in an upper layer with respect to at least one of the first content displayed in the target content display region or the second content displayed in the navigation bar display region.

In the above implementation, the first associated special effect may be presented in an upper layer of the content displayed in the first special effect display region. Furthermore, when the second associated special effect for the preset keyword needs to be presented, the second associated special effect may be presented in an upper layer of the second content displayed in the navigation bar display region. For example, assuming that the display page includes a first image layer, a second image layer, a third image layer, and a fourth image layer which are sequentially stacked from top to bottom in a direction perpendicular to the screen, the first associated special effect or the second associated special effect may be presented in the first image layer, the second associated special effect or the first associated special effect may be presented in the second image layer, the first content or the second content may be displayed in the third image layer, and the second content or the first content may be displayed in the fourth image layer.

In order to improve the authenticity of the associated special effects presented, in an embodiment, when the target content display region is located within the first special effect display region, the second special effect display region may be provided, and the third special effect display region may or may not be provided as desired. When the target content display region is located outside the first special effect display region, the second special effect display region may be provided, and the third special effect display region is not provided. When the target content display region is located within the first special effect display region and the third special effect display region is provided, the first associated special effect may be presented in an upper layer of at least one of the first content displayed in the target content display region or the second content displayed in the navigation bar display region. When the target content display region is located within the first special effect display region and the third special effect display region is not provided, the first associated special effect may be presented in a lower layer of the first content displayed in the target content display region and in an upper layer of the second content displayed in the navigation bar display region. When the target content display region is located outside the first special effect display region, the first associated special effect may be presented in an upper layer of the second content displayed in the navigation bar display region.
S203: in response to a sliding operation along a preset direction, controlling the target multimedia content to move in synchronization with the associated special effect along the preset direction.

When the content display regions on the display page are arranged laterally on the display page, the preset direction may be a vertical direction; and when the content display regions on the display page are arranged vertically on the display page, the preset direction may be a transverse direction. Hereinafter, the content display regions being arranged vertically on the display page are taken as an example. The associated special effects for the preset keyword may include the first associated special effect and may further include the second associated special effect.

For example, when a vertical sliding operation acting on the display page is received, such as when the user slides upwards on the display page, the associated special effects presented on the display page may be controlled to move in synchronization with the target multimedia content and/or non-target multimedia content displayed on the display page along the sliding direction of the user, to move the multimedia content located outside the display region of the display page into the display region of the display page for presentation, so as to provide for the user to view.

Furthermore, when a lateral sliding operation acting within the target content display region is received, the multimedia content displayed in the target content display region may be switched. For example, the target multimedia content displayed in the target content display region may be switched, and/or the target multimedia content displayed in the target content display region may be switched to a non-target multimedia content belonging to the same topic as the target multimedia content. When a lateral sliding operation acting outside the target content display region is received, for example, when a lateral sliding operation acting on another content display region other than the target content display region is received, the current page may be switched from the display page to another page, for example, the page switching may be performed according to the order of the page labels in the navigation bar and along the sliding direction of the lateral sliding of the user.

In the content display method provided by the present embodiment, when the target multimedia content associated with the preset keyword is displayed, the first associated special effect for the preset keyword is presented in the first special effect display region associated with the target content display region in which the target multimedia content is located, and the second associated special effect for the preset keyword is presented in at least one of the second special effect display region or the third special effect display region associated with the target content display region, thereby improving the realism of the presented special effects, and highlighting the target multimedia content displayed on the display page, thus improving the experience of the user.

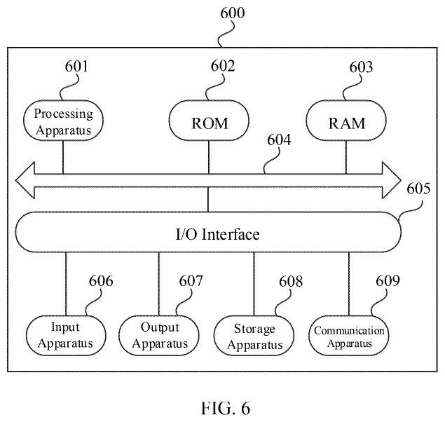

FIG. 5 is a structural block diagram of a content display apparatus provided by an embodiment of the present disclosure. The apparatus may be implemented by software and/or hardware, and may be configured in the electronic device. For example, it may be configured in a mobile phone or a tablet computer, and may achieve display of the specific multimedia content by executing the content display method. As illustrated in FIG. 5, the content display apparatus provided by the embodiment may include a receiving module 501 and a display module 502.

The receiving module 501 is configured to receive a display operation for a target multimedia content, where the target multimedia content is a content associated with a preset keyword.

The display module 502 is configured to, in response to the display operation, display the target multimedia content in a target content display region of a display page, and present an associated special effect for the preset keyword in a first special effect display region associated with the target content display region, where at least two content display regions are provided in a main display region of the display page, the content display regions comprise the target content display region, and a content display region other than the target content display region is located outside the first special effect display region.

For the content display apparatus provided by the embodiment, the receiving module is configured to receive a display operation for a target multimedia content associated with a preset keyword, and the display module is configured to, in response to the display operation, display the target multimedia content in a target content display region of a display page, and present an associated special effect for the preset keyword in a first special effect display region associated with the target content display region, where at least two content display regions, including the target content display region, are provided in a main display region of the display page, and a content display region other than the target content display region is located outside the first special effect display region. By adopting the above technical solution, in the present embodiment, when the target multimedia content associated with the preset keyword is displayed, the special effects associated with the preset keyword are presented in the special effect display region associated with the content display region in which the target multimedia content is located, which thus can not only enhance the fun of display of the multimedia content and create an immersive viewing experience for the user, but also can highlight the target multimedia content presented on the page by the special effects, so as to improve the recognizability of the target multimedia content and improve the user's attention to the target multimedia content, thereby improving the experience of the user.

In the above solution, the display module 502 is further configured to: present a first associated special effect for the preset keyword in the first special effect display region associated with the target content display region.

In the above solution, the display module 502 is further configured to: present a second associated special effect for the preset keyword in a second special effect display region within the first special effect display region, where the second special effect display region is located above the target content display region.

In the above solution, both of the first associated special effect and the second associated special effect may include a plurality of target objects associated with the preset keyword, the target objects included in the first associated special effect may move downwards in the first special effect display region, and the target objects included in the second associated special effect may be stacked at bottom of the second special effect display region.

In the above solution, the target content display region may be located within the first special effect display region.

In the above solution, a navigation bar display region may further be provided on the display page, the navigation bar display region may be located above the main display region, the first associated special effect is presented in a lower layer with respect to a first content displayed in the target content display region, and is presented in an upper layer with respect to a second content displayed in the navigation bar display region, and the second associated special effect is presented in an upper layer with respect to the second content displayed in the navigation bar display region, where the first content includes the target multimedia content.

In the above solution, the display module 502 is further configured to: present the second associated special effect for the preset keyword in a third special effect display region within the first special effect display region, where the third special effect display region is located within the target content display region.

In the above solution, a navigation bar display region may further be provided on the display page, the navigation bar display region may be located above the main display region, the first associated special effect is presented in an upper layer with respect to a first content displayed in the target content display region and a second content displayed in the navigation bar display region, and the second associated special effect is presented in an upper layer with respect to at least one of: the first content displayed in the target content display region or the second content displayed in the navigation bar display region.

In the above solution, the target content display region may be located below the first special effect display region.

For example, the content display apparatus provided by the embodiment may further include a move control module, and the move control module is configured to, in response to a sliding operation along a preset direction, control the target multimedia content to move in synchronization with the associated special effect along the preset direction.

In the above solution, the target multimedia content may be a content complying with a preset condition among contents associated with the preset keyword.

In the above solution, the display operation may be at least one of a search operation or a viewing operation, a search result of the search operation may include the target multimedia content, and the viewing operation may be an operation for viewing the target multimedia content.

The content display apparatus provided by the embodiments of the present disclosure may execute the content display method provided by any one of the embodiments of the present disclosure, and can have corresponding functional modules and beneficial effects for executing the content display method. Technical details that are not fully described in the embodiment may refer to those in the content display method provided by any one of the embodiments of the present disclosure.

In the following, referring to FIG. 6, a schematic structural diagram of an electronic device (e.g., a terminal device) 600 suitable for implementing the embodiments of the present disclosure is illustrated. For example, the terminal device in the embodiments of the present disclosure may include mobile terminals, such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), etc., and fixed terminals, such as a digital television (TV), a desktop computer, etc. It should be noted that the electronic device shown in FIG. 6 is merely an example.

As illustrated in FIG. 6, the electronic device 600 may include a processing apparatus 601 (e.g., a central processing unit, a graphics processing unit, etc.). The electronic device 600 may execute various appropriate actions and processing according to a program stored on a read-only memory (ROM) 602 or a program loaded from a storage apparatus 608 into a random access memory (RAM) 603. The RAM 603 further stores various programs and data required for operation of the electronic device 600. The processing apparatus 601, the ROM 602, and the RAM 603 are connected with each other through a bus 604. An input/output (I/O) interface 605 is also connected to the bus 604.

Usually, apparatuses below may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a speaker, a vibrator, or the like; a storage apparatus 608 including, for example, a magnetic tape, a hard disk, or the like; and a communication apparatus 609. The communication apparatus 609 may allow the electronic device 600 to perform wireless or wired communication with other electronic devices so as to exchange data. Although FIG. 6 shows the electronic device 600 having various apparatuses, it should be understood that, it is not required to implement or have all the apparatuses illustrated, and the electronic device may alternatively implement or have more or fewer apparatuses.

In an embodiment, according to the embodiments of the present disclosure, the process described above with reference to the flowchart may be implemented as computer software programs. For example, the embodiments of the present disclosure include a computer program product, including a computer program carried on a non-transitory computer-readable medium, and the computer program includes program codes for executing the method shown in the flowchart. In such embodiments, the computer program may be downloaded and installed from the network via the communication apparatus 609, or installed from the storage apparatus 608, or installed from the ROM 602. When executed by the processing apparatus 601, the computer program may implement the above functions defined in the method provided by the embodiments of the present disclosure.

It should be noted that, the computer-readable medium described in the present disclosure may be a computer-readable signal medium or a computer-readable storage medium, or any combination thereof. For example, the computer-readable storage medium may be an electric, magnetic, optical, electromagnetic, infrared, or semiconductor system, apparatus or device, or any combination thereof. For example, the computer-readable storage medium may include: an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program codes contained on the computer-readable medium may be transmitted by using any suitable medium, including an electric wire, a fiber-optic cable, radio frequency (RF) and the like, or any appropriate combination of them.

In some implementations, the client terminal and the server may communicate with any network protocol currently known or to be researched and developed in the future such as hypertext transfer protocol (HTTP), and may communicate (for example, via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-described computer-readable medium may be included in the above-described electronic device, or may also exist alone without being assembled into the electronic device.

The above-mentioned computer-readable medium carries one or more programs, and the one or more programs, when executed by the electronic device, cause the electronic device to: receive a display operation for a target multimedia content, where the target multimedia content is a content associated with a preset keyword; and in response to the display operation, display the target multimedia content in a target content display region of a display page, and present an associated special effect for the preset keyword in a first special effect display region associated with the target content display region, where at least two content display regions are provided in a main display region of the display page, the content display regions comprise the target content display region, and a content display region other than the target content display region is located outside the first special effect display region.

The computer program codes for performing the operations of the present disclosure may be written in one or more programming languages or a combination thereof. The above-described programming languages include but are not limited to object-oriented programming languages, such as Java, Smalltalk, C++, and also include conventional procedural programming languages, such as the “C” programming language or similar programming languages. The program codes may by executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flow chart and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. The name of the module does not constitute a limitation of the unit itself under certain circumstances.

The functions described herein above may be performed, at least partially, by one or more hardware logic components. For example, available exemplary types of hardware logic components include: a field programmable gate array (FPGA), an application specific integrated circuit (ASIC), application specific standard parts (ASSP), a system on chip (SOC), a complex programmable logical device (CPLD), etc.

In the context of the present disclosure, the machine-readable medium may be a tangible medium containing or storing a program that can be used by or in combination with an instruction execution system, apparatus or device. The machine-readable medium may be a machine-readable signal medium or a machine-readable storage medium. The machine-readable medium may include an electric, magnetic, optical, electromagnetic, infrared, or semiconductor system, apparatus or device, or any appropriate combination thereof. Examples of the machine-readable storage medium may include: an electrical connection based on one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them.

According to one or more embodiments of the present disclosure, Example 1 provides a content display method, comprising:
receiving a display operation for a target multimedia content, wherein the target multimedia content is a content associated with a preset keyword; and
in response to the display operation, displaying the target multimedia content in a target content display region of a display page, and presenting an associated special effect for the preset keyword in a first special effect display region associated with the target content display region, wherein at least two content display regions are provided in a main display region of the display page, the content display regions comprise the target content display region, and a content display region other than the target content display region is located outside the first special effect display region.

According to one or more embodiments of the present disclosure, in the method of Example 2 according to Example 1, presenting the associated special effect for the preset keyword in the first special effect display region associated with the target content display region comprises:
presenting a first associated special effect for the preset keyword in the first special effect display region associated with the target content display region.

According to one or more embodiments of the present disclosure, in the method of Example 3 according to Example 2, presenting the associated special effect for the preset keyword in the first special effect display region associated with the target content display region comprises:
presenting a second associated special effect for the preset keyword in a second special effect display region within the first special effect display region, wherein the second special effect display region is located above the target content display region.

According to one or more embodiments of the present disclosure, in the method of Example 4 according to Example 3, both of the first associated special effect and the second associated special effect comprise a plurality of target objects associated with the preset keyword, the target objects comprised in the first associated special effect move downwards in the first special effect display region, and the target objects comprised in the second associated special effect are stacked at bottom of the second special effect display region.

According to one or more embodiments of the present disclosure, in the method of Example 5 according to Example 3 or 4, the target content display region is located within the first special effect display region.

According to one or more embodiments of the present disclosure, in the method of Example 6 according to Example 5, a navigation bar display region is further provided on the display page, the navigation bar display region being located above the main display region, the first associated special effect is presented in a lower layer with respect to a first content displayed in the target content display region, and is presented in an upper layer with respect to a second content displayed in the navigation bar display region, and the second associated special effect is presented in an upper layer with respect to the second content displayed in the navigation bar display region, wherein the first content comprises the target multimedia content.

According to one or more embodiments of the present disclosure, in the method of Example 7 according to Example 5, presenting the associated special effect for the preset keyword in the first special effect display region associated with the target content display region comprises:
presenting the second associated special effect for the preset keyword in a third special effect display region within the first special effect display region, wherein the third special effect display region is located within the target content display region.

According to one or more embodiments of the present disclosure, in the method of Example 8 according to Example 7, a navigation bar display region is further provided on the display page, the navigation bar display region being located above the main display region, the first associated special effect is presented in an upper layer with respect to a first content displayed in the target content display region and a second content displayed in the navigation bar display region, and the second associated special effect is presented in an upper layer with respect to at least one of: the first content displayed in the target content display region or the second content displayed in the navigation bar display region.

According to one or more embodiments of the present disclosure, in the method of Example 9 according to any one of Examples 1-4, the target content display region is located below the first special effect display region.

According to one or more embodiments of the present disclosure, the method of Example 10 according to any one of Examples 1˜4 further comprises:
in response to a sliding operation along a preset direction, controlling the target multimedia content to move in synchronization with the associated special effect along the preset direction.

According to one or more embodiments of the present disclosure, in the method of Example 11 according to any one of Examples 1-4, the target multimedia content is a content complying with a preset condition among contents associated with the preset keyword.

According to one or more embodiments of the present disclosure, in the method of Example 12 according to any one of Examples 1-4, the display operation is at least one of a search operation or a viewing operation, a search result of the search operation comprises the target multimedia content, and the viewing operation is an operation for viewing the target multimedia content.

According to one or more embodiments of the present disclosure, Example 13 provides a content display apparatus, comprising:
a receiving module, configured to receive a display operation for a target multimedia content, wherein the target multimedia content is a content associated with a preset keyword; and
a display module, configured to, in response to the display operation, display the target multimedia content in a target content display region of a display page, and present an associated special effect for the preset keyword in a first special effect display region associated with the target content display region, wherein at least two content display regions are provided in a main display region of the display page, the content display regions comprise the target content display region, and a content display region other than the target content display region is located outside the first special effect display region.

According to one or more embodiments of the present disclosure, Example 14 provides an electronic device, comprising:
a processor; and
a memory, configured to store a program,
wherein the program, when executed by the processor, causes the processor to implement the content display method according to any one of Examples 1 to 12.

According to one or more embodiments of the present disclosure, Example 15 provides a computer-readable storage medium, a computer program is stored on the computer-readable storage medium, and the computer program, when executed by a processor, causes the processor to implement the content display method according to any one of Examples 1 to 12.

According to one or more embodiments of the present disclosure, Example 16 provides a computer program product, and the computer program product, when executed by a computer, causes the computer to implement the content display method according to any one of Examples 1 to 12.

1. A content display method, comprising:
receiving a display operation for a target multimedia content, wherein the target multimedia content is a content associated with a preset keyword; and
in response to the display operation, displaying the target multimedia content in a target content display region of a display page, and presenting an associated effect for the preset keyword in a first effect display region associated with the target content display region,
wherein at least two content display regions are provided in a main display region of the display page, the at least two content display regions comprise the target content display region, and a content display region comprised in the at least two content display regions other than the target content display region is located outside the first effect display region.

2. The method according to claim 1, wherein presenting the associated effect for the preset keyword in the first effect display region associated with the target content display region comprises:
presenting a first associated effect for the preset keyword in the first effect display region associated with the target content display region.

3. The method according to claim 2, wherein presenting the associated effect for the preset keyword in the first effect display region associated with the target content display region comprises:
presenting a second associated effect for the preset keyword in a second effect display region within the first effect display region,
wherein the second effect display region is located above the target content display region.

4. The method according to claim 3, wherein the first associated effect comprises a plurality of first target objects associated with the preset keyword, the second associated effect comprises a plurality of second target objects associated with the preset keyword, the target first objects comprised in the first associated effect move downwards in the first effect display region, and the second target objects comprised in the second associated effect are stacked at bottom of the second effect display region.

5. The method according to claim 3, wherein the target content display region is located within the first effect display region.

6. The method according to claim 5, wherein a navigation bar display region is further provided on the display page, the navigation bar display region being located above the main display region,
the first associated effect is presented in a lower layer with respect to a first content displayed in the target content display region, and is presented in an upper layer with respect to a second content displayed in the navigation bar display region, and
the second associated effect is presented in an upper layer with respect to the second content displayed in the navigation bar display region,
wherein the first content comprises the target multimedia content.

7. The method according to claim 5, wherein presenting the associated effect for the preset keyword in the first effect display region associated with the target content display region comprises:
presenting the second associated effect for the preset keyword in a third effect display region within the first effect display region, wherein the third effect display region is located within the target content display region.

8. The method according to claim 7, wherein a navigation bar display region is further provided on the display page, the navigation bar display region being located above the main display region,
the first associated effect is presented in an upper layer with respect to a first content displayed in the target content display region and a second content displayed in the navigation bar display region, and
the second associated effect is presented in an upper layer with respect to at least one of: the first content displayed in the target content display region or the second content displayed in the navigation bar display region.

9. The method according to claim 1, wherein the target content display region is located below the first effect display region.

10. The method according to claim 1, further comprising:
in response to a sliding operation along a preset direction, controlling the target multimedia content to move in synchronization with the associated effect along the preset direction.

11. The method according to claim 1, wherein the target multimedia content is a content complying with a preset condition among contents associated with the preset keyword.

12. The method according to claim 1, wherein the display operation is configured to comprise at least one of a search operation or a viewing operation, a search result of the search operation comprises the target multimedia content, and the viewing operation is an operation for viewing the target multimedia content.

13. A content display apparatus, comprising:
a receiving module, configured to receive a display operation for a target multimedia content, wherein the target multimedia content is a content associated with a preset keyword; and
a display module, configured to, in response to the display operation, display the target multimedia content in a target content display region of a display page, and present an associated effect for the preset keyword in a first effect display region associated with the target content display region,
wherein at least two content display regions are provided in a main display region of the display page, the at least two content display regions comprise the target content display region, and a content display region comprised in the at least two content display regions other than the target content display region is located outside the first effect display region.

14. An electronic device, comprising:
a processor; and
a memory, configured to store a program,
wherein the program, when executed by the processor, causes the processor to implement the content display method according to claim 1.

15. A computer-readable storage medium, wherein a computer program is stored on the computer-readable storage medium, and the computer program, when executed by a processor, causes the processor to:
receive a display operation for a target multimedia content, wherein the target multimedia content is a content associated with a preset keyword; and
in response to the display operation, display the target multimedia content in a target content display region of a display page, and present an associated effect for the preset keyword in a first effect display region associated with the target content display region,
wherein at least two content display regions are provided in a main display region of the display page, the at least two content display regions comprise the target content display region, and a content display region comprised in the at least two content display regions other than the target content display region is located outside the first effect display region.

16. A computer program product, wherein the computer program product, when executed by a computer, causes the computer to implement the content display method according to claim 1.

17. The apparatus according to claim 13, wherein the display module is further configured to present a first associated effect for the preset keyword in the first effect display region associated with the target content display region.

18. The apparatus according to claim 17, wherein the display module is further configured to present a second associated effect for the preset keyword in a second effect display region within the first effect display region, wherein the second effect display region is located above the target content display region.

19. The apparatus according to claim 18, wherein the first associated effect comprises a plurality of first target objects associated with the preset keyword, the second associated effect comprises a plurality of second target objects associated with the preset keyword, the first target objects comprised in the first associated effect move downwards in the first effect display region, and the second target objects comprised in the second associated effect are stacked at bottom of the second effect display region.

20. The apparatus according to claim 18, wherein the target content display region is located within the first effect display region.
